(19) United States
(12) Patent Application Publication
(10) Pub. No.: US 2025/0341130 A1
(43) Pub. Date: Nov. 6, 2025

(54) DRAINAGE APPARATUS

(71) Applicants: MS Consultants, Inc., Columbus, OH (US); Ohio State Innovation Foundation, Columbus, OH (US); University of Iowa Research Foundation, Iowa City, IA (US)

(72) Inventors: Anil Tangirala, Lewis Center, OH (US); Justin Kerns, Pittsburgh, PA (US); Andrew Tirpak, Columbus, OH (US); Ryan Winston, Upper Arlington, OH (US); Tony Loeser, Iowa City, IA (US); Troy Lyons, Riverside, IA (US)

(21) Appl. No.: 19/197,579

(22) Filed: May 2, 2025

Related U.S. Application Data
(60) Provisional application No. 63/641,753, filed on May 2, 2024.

(51) Int. Cl. E06B 7/14

(52) U.S. Cl. CPC E06B 7/14

(57) ABSTRACT

A drainage apparatus adapted to extend over a window for drainage. The drainage apparatus is comprised of at least one piece of sheet metal, which defines a first end portion and a second end portion that are, respectively, adapted to extend over a face of a window for drainage. Each end portion defines at least one elongated opening configured for receiving a fastener adapted to secure the drainage apparatus, respectively, over different sizes of windows for drainage. A middle portion is defined between the first end portion and the second end portion, wherein the middle portion defines a plurality of drainage openings that, respectively, have a dimension of at least two inches to perform the screening function.

This application claims the priority benefit of U.S. Provisional Application No. 63/641,753, filed May 2, 2024, which is hereby incorporated by reference in its entirety.

### BACKGROUND AND SUMMARY OF THE INVENTION

Exemplary embodiments of the present invention relate generally to drainage filtration.

Barrier inlet screens are known to prevent debris from entering a drainage inlet. Debris may include small debris or sediment, and also larger debris. Exemplary embodiments of the present invention are focused on a drainage apparatus adapted to screen out larger debris and provide adequate hydraulic capacity while minimizing maintenance, unless otherwise noted.

Known barrier products for screening larger debris generally fall into one of three categories: under-grate baskets, outlet pipe protection, and screen/bar devices.

Known under-grate basket style devices hang below the inlet opening and capture debris as it falls through the grate or window opening. The basket must be cleaned out when it reaches capacity. Once the device exceeds capacity, debris can spill into the storm structure where it is free to discharge through the outlet pipes.

Known outlet pipe protection style devices are installed within the storm structure and prevent debris from exiting the structure through the pipe. Debris will accumulate within the storm structure and must be vacuumed out. On the other hand, known screen/bar style devices are bolted to the face or inside the inlet window opening and block debris from entering the storm structure. Street sweeping and debris removal is necessary to prevent excess accumulation of debris on the roadway, which may restrict hydraulic capacity.

Known bar/screen devices are typically fabricated from stainless steel, aluminum, or High-Density Polyethylene (HDPE). The screens are typically fastened to the barrier in such a fashion to make them nearly flush with the face of the window, which typically requires a cumbersome installation, and which often is not adaptable to different sizes of window openings. An overflow relief mechanism is typically integrated into the device to allow for storm water to bypass the screen in the event of high flows or excessive debris accumulation. Known bar/screen style devices fall into three categories: fixed screens, automatically retractable screens, and manual retractable screens.

Known fixed screens are static devices that block debris from entering the inlet window. They consist of a rigid screen or fixed bars mounted to the inside or outside of the window opening. The devices stay in place at all times and typically have an opening between the top of the device and top of the inlet window to act as an emergency overflow. Manual retractable screens are similar to fixed screens, but they need to be opened/closed for maintenance or during emergency flooding events. Automatically retractable screens (ARS) are inlet covers that have a self-opening mechanism that functions as an emergency overflow. The screens may open horizontally or vertically and are typically controlled by a pressure calibrated spring. Other ARS designs may include flexible HDPE “flaps” that have free movement and will gradually open and allow more flow to pass through during larger storm events.

Known fixed screen devices have many disadvantages, which include limited overall sizes, limited screen openings (e.g., too small and/or disadvantageous shapes), disadvantageous materials, disadvantageous attachment methods, disadvantageous manufacturing processes, and/or inability to retrofit. Some known bar/screen devices may have relatively small openings (some less than ½-inch), which may lead to being clogged with sediment. There is a need for larger bar spacing for the exemplary embodiments.

Exemplary embodiments may satisfy at least one of the aforementioned needs. In one exemplary embodiment, a drainage apparatus is provided that is adapted to extend over a window for drainage. In one example, the drainage apparatus is substantially planar, which may best facilitate ease of installation and/or removal of screened debris. However, other exemplary embodiments may not be substantially planar yet still facilitate ease of installation and/or removal of screened debris compared to the known art.

In an exemplary embodiment, the drainage apparatus is comprised of at least one piece of sheet metal. The at least one piece of sheet metal defines at least a first end portion and a second end portion, which may oppose each other in one embodiment. The first end portion and the second end portion, respectively, are adapted to extend over a face of a window for drainage, wherein each end portion defines at least one elongated opening configured for receiving a fastener adapted to secure the drainage apparatus over, respectively, different sizes of windows for drainage. In particular, the elongated openings allow for adjustable positioning of a fastener in the face of a window to account for different sizes. For instance, one exemplary embodiment of at least one elongated opening of a first end portion and/or a second end portion, respectively, has a length of about 4 inches. Other examples of an elongated opening may have a shorter or longer length and/or other dimensions or shapes to provide the desired adaptability for different sizes and shapes of windows for drainage.

In one exemplary embodiment, at least one elongated opening of the first end portion and/or the second end portion is, respectively, a slot. In one example, the at least one elongated opening of the first end portion and/or the second end portion is, respectively, at least a pair of the elongated openings (e.g., slots). As aforementioned, other exemplary embodiments of an elongated opening may also have different sizes or shapes to provide the desired adaptability for different sizes and shapes of windows for drainage.

In an exemplary embodiment, the at least one piece of sheet metal further defines a middle portion between the first end portion and the second end portion. The middle portion defines a plurality of drainage openings that are adapted to facilitate drainage. In an exemplary embodiment, the drainage openings may also limit the buildup of relatively small sediment. In one example, the middle portion may further define at least one opening configured for receiving a fastener adapted to assist with securing the drainage apparatus, respectively, over different sizes of windows for drainage.

At the same time, the middle portion is adapted to screen debris larger than the drainage openings such it does not continue to flow downstream. In an exemplary embodiment, the drainage openings, respectively, have a dimension of at least two inches. In one example, a plurality of drainage openings, respectively, have a rectangular shape. The rectangular shape may have a length of about 10 inches in one embodiment for screening large debris such as, but not limited to, bucket lids. In another example, a plurality of drainage openings, respectively, have a parallelogram shape. The parallelogram shape may have a length of about 4.75 inches in one embodiment for screening large debris such as, but not limited to, large bottles.

In one example, the at least one piece of sheet metal is at least a first piece of sheet metal that is secured (e.g., welded) to a second piece of sheet metal. Other types of securement may also be used in other exemplary embodiments. For example, in one embodiment, a first piece of sheet metal may define a first end portion, and a second piece of sheet metal may define a second end portion, wherein the first piece of sheet metal is secured to the second piece of sheet metal to form the middle portion.

In one exemplary embodiment, the drainage apparatus has a length of about 11 feet and a width of about 3 inches. In another exemplary embodiment, the drainage apparatus also has a length of about 11 feet and a width of about 6.5 inches. Other exemplary embodiments may have a shorter or longer length and width. Also, other exemplary embodiments may have any other dimensions and shapes (e.g., angular, round, curved, etc.) that enable the drainage apparatus to be secured to the face of the intended window for drainage.

In these examples, the drainage apparatus is substantially planar, which may best facilitate ease of installation and/or removal of screened debris. However, other exemplary embodiments may not be substantially planar yet still facilitate ease of installation and/or removal of screened debris compared to the known art.

In each of these exemplary embodiments, the drainage apparatus is also a unit, which further facilitates ease of installation. However, other exemplary embodiments may not be a unit, yet still may be substantially planar or otherwise still facilitate ease of installation compared to the known art.

In addition to the novel features and advantages mentioned above, other benefits will be readily apparent from the following descriptions of the drawings and exemplary embodiments.

### BRIEF DESCRIPTION OF THE DRAWINGS

FIG. 1 is a side elevation view of an exemplary embodiment of a drainage apparatus of the present invention.

FIG. 2 is a detail view of the left end portion of the drainage apparatus of FIG. 1.

FIG. 3 is a detailed, cross-sectional view of the drainage apparatus of FIG. 1, wherein an exemplary installation of the drainage apparatus is also shown with a fastener extending into a support surface (e.g., concrete) of a window surround.

FIG. 4 is a side elevation view of an exemplary embodiment of a drainage apparatus of the present invention.

### DETAILED DESCRIPTION OF EXEMPLARY EMBODIMENT(S)

Exemplary embodiments of the present invention are directed to a drainage apparatus and its related design and method of being manufactured.

The inventors fabricated multiple embodiments in-house, and also in-lab created screen devices of the present invention. The research allowed the inventors to specify design parameters such as: bar spacing, bar size, attachment mechanisms, etc.

The fabricated embodiments were adapted to be easily attached to existing barrier inlets. Exemplary embodiments were also adapted to be used as a retrofit option.

Exemplary embodiments were designed to take into account the type of debris likely to be encountered such as, but not limited to, along a roadway or sidewalk. Some of the most common types of debris are plastic soda bottles and aluminum cans. The average diameter of a 12 Fl. Oz. aluminum can is 2.12 inches, while the average diameter of a 20 Fl. Oz. plastic bottle is 2.08 inches. Therefore, one exemplary embodiment of a drainage apparatus may have minimum horizontal bar spacing of about 2-inches.

Other commonly observed roadway debris are hub caps and 5-gallon bucket lids. These items have similar geometry. A typical 5-gallon bucket lid is approximately 12-inches in diameter. Therefore, another exemplary embodiment may have horizontal bar spacing up to about 10-inches or more. As addressed further below, other exemplary embodiments may have different types, shapes, and sizes of spacing to account for the expected debris.

One exemplary embodiment was fabricated via CNC machining out of ¼-inch steel plate such that it could be bolted or screwed onto a concrete barrier (e.g., on either side of a window opening, with tap-con screws) as a new installation or as a retrofit. This embodiment of a steel plate also has a galvanized/zinc coating to assist with wear.

Other exemplary embodiments may be manufactured using other metals, plastics, composites, or other materials suitable for an intended installation. Likewise, while CNC machining is preferable, other suitable manufacturing methods may be used for the selected material unless otherwise noted.

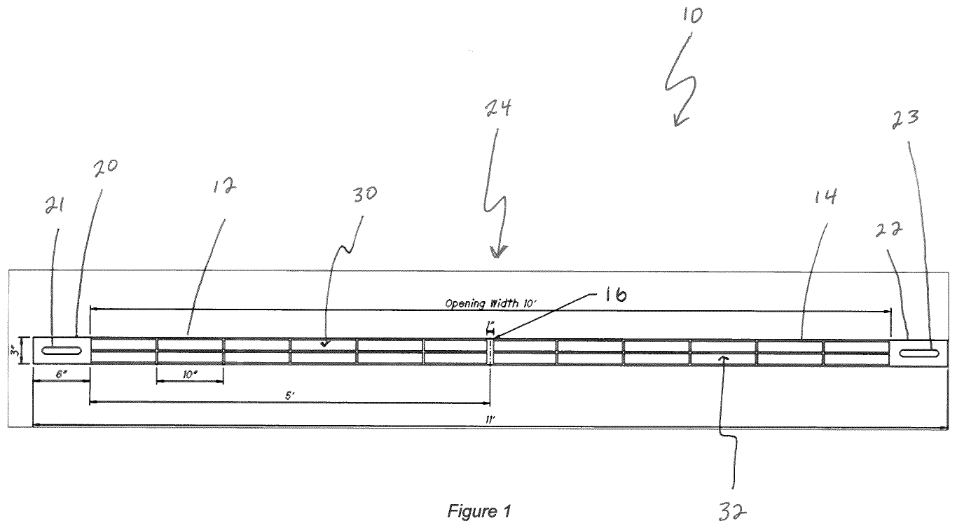

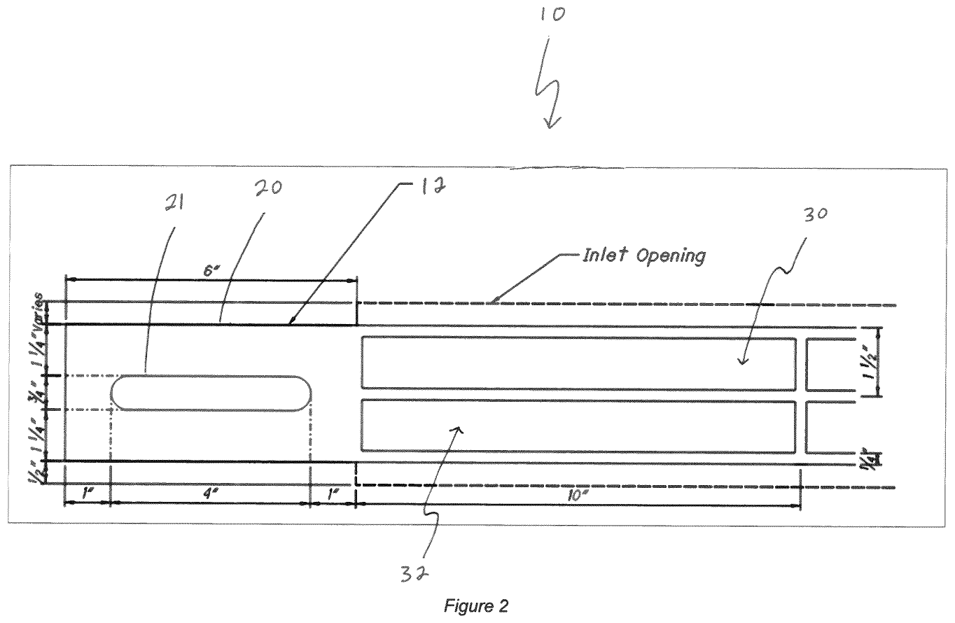

FIGS. 1-3 show drawings of one fabricated embodiment of a drainage apparatus 10. This embodiment was designed for use over a window for drainage having an opening that extends about 10 inches in length. However, unless otherwise noted, the design concepts may be carried over to other drainage apparatus for other size window openings.

The drainage apparatus 10 is comprised of at least one piece of sheet metal 12. In particular, this embodiment of drainage apparatus 10 is comprised of a first piece of sheet metal 12 that is secured to a second piece of sheet metal 14. In this example, the first piece of sheet metal 12 is welded (see weld 16) to the second piece of sheet metal 14. As aforementioned, other types of securement may also be used, if needed, in other exemplary embodiments.

In this embodiment, drainage apparatus 10 defines a first end portion 20, a second end portion 22, and a middle portion 24 between first end portion 20 and second end portion 22. More particularly, in this embodiment, the first piece of sheet metal 12 defines first end portion 20, and the second piece of sheet metal 14 defines second end portion 22, wherein the first piece of sheet metal 12 is secured to the second piece of sheet metal 14 to form the middle portion 24. Other embodiments may comprise three or more pieces of sheet metal (or another material) in the same manner. In this example, each piece of sheet metal is five feet in length. However, other dimensions of a piece of sheet metal or other material may be used in other exemplary embodiments.

In this embodiment, the first end portion 20 and second end portion 22 oppose each other. The first end portion 20 and the second end portion 22, respectively, are adapted to extend over a face of a window for drainage to facilitate securement. In this example, each end portion is six inches in length, however other dimensions of an end portion may be used in other exemplary embodiments. As aforementioned, other exemplary embodiments of a drainage apparatus may have different dimensions and/or shapes (e.g., angular, round, curved, etc.) that enable the drainage apparatus to be secured to the face of the intended window for drainage.

Each end portion defines at least one elongated opening configured for receiving a fastener adapted to secure the drainage apparatus over, respectively, different sizes of windows for drainage. In this embodiment, first end portion 20 defines elongated opening 21, and second end portion 22 defines elongated opening 23. The elongated openings allow for adjustable positioning of at least one fastener in the face of a window to account for different sizes. For instance, in this exemplary embodiment, elongated opening 21 and elongated opening 23, respectively, have a length of about 4 inches. Other examples of an elongated opening may have a shorter or longer length and/or other dimensions or shapes to provide the desired adaptability for different sizes and shapes of windows for drainage.

More particularly, in this exemplary embodiment, elongated opening 21 and elongated opening 23 are, respectively, a slot. In some other exemplary embodiments, at least one (e.g., three or more) elongated opening(s) may, respectively, be a slot to allow the desired adaptability. In addition, some exemplary embodiments may, respectively, have at least a pair of elongated openings (e.g., slots) on at least one end portion.

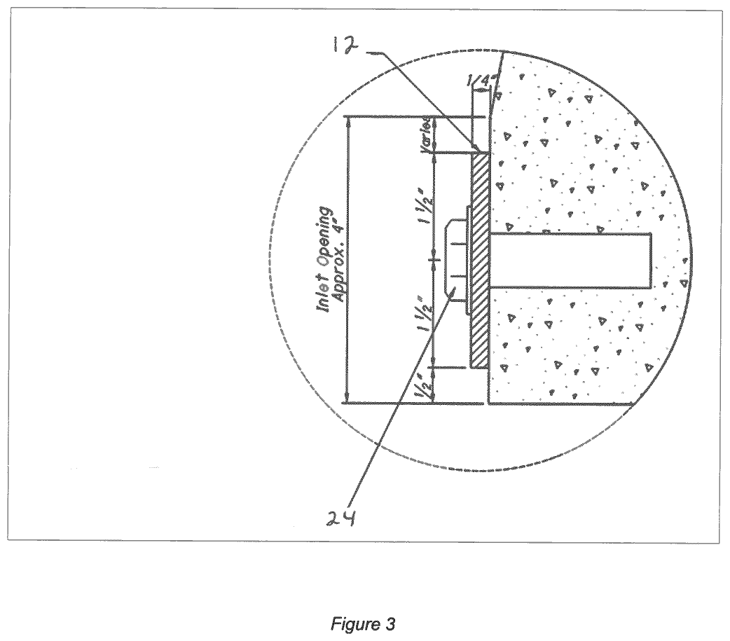

FIG. 3 shows an exemplary installation in which at least one fastener 24 (e.g., a screw, bolt, or other suitable fastener) extends through an elongated opening to secure drainage apparatus 12 to a support surface (e.g., a face of a window for drainage).

Middle portion 24 defines a plurality of drainage openings (see, e.g., representative drainage opening 30 and drainage opening 32) between first end portion 20 and second end portion 22 that are adapted to facilitate drainage. In the exemplary embodiment, the drainage openings may also limit the buildup of relatively small sediment. In this embodiment, the drainage openings are arranged in rows and columns. In some other exemplary embodiments, the drainage openings may have a different orderly or random configuration that provides the desired screening function.

More particularly, middle portion 24 is adapted to screen debris larger than the drainage openings (see, e.g., representative drainage opening 30 and drainage opening 32) such that the large debris does not flow downstream into a storm structure. In one exemplary embodiment, the drainage openings, respectively, have a dimension of at least two inches. In this example, the drainage openings (see, e.g., representative drainage opening 30 and drainage opening 32), respectively, have a rectangular shape. The rectangular shape has a length of about 10 inches in this embodiment for screening large debris such as, but not limited to, bucket lids. Other exemplary embodiments may have drainage openings that have different lengths or shapes to perform the desired screening function.

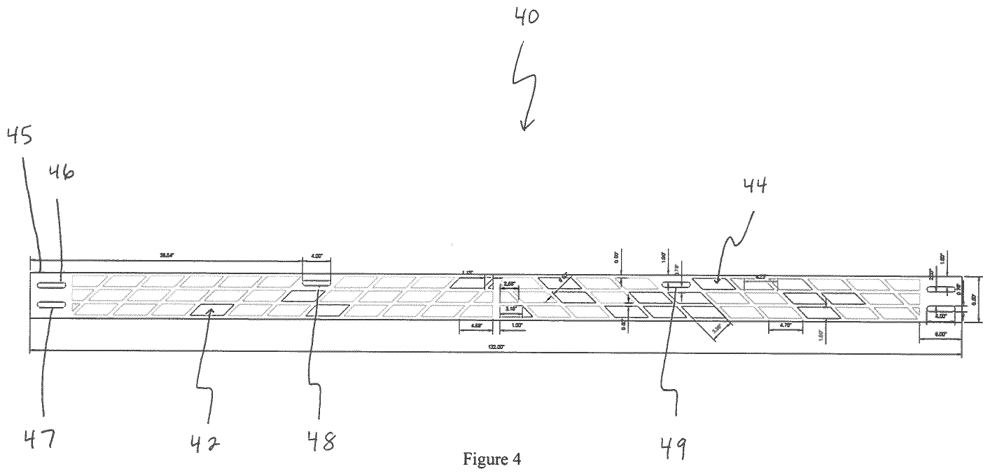

In another example, FIG. 4 shows an example of drainage apparatus 40. Drainage apparatus 40 has a plurality of drainage openings (see, e.g., representative drainage opening 42 and drainage opening 44), respectively, having parallelogram shapes that allow for a variety of select small debris (e.g., sediment) to pass through while screening other undesired larger types of debris. In this example, the parallelogram shapes, respectively, have a length of about 4.75 inches, such as for screening large debris including, but not limited to, large bottles. More particularly, FIG. 4 shows an example of representative drainage opening 42 having a different configuration than representative drainage opening 44. As aforementioned, other dimensions and shapes of drainage openings may be used to perform the desired screening function. Drainage apparatus 40 also shows an example of at least one end portion 45 defining at least a pair of elongated openings (see elongated opening 46 and elongated opening 47).

In this example, the middle portion of drainage apparatus 40 also further defines at least one opening (see, e.g., opening 48 and opening 49) configured for receiving a fastener adapted to assist with securing the drainage apparatus over, respectively, different sizes of windows for drainage. More particularly, in this exemplary embodiment, opening 48 is located in one intermediate portion comprising drainage openings 42, and opening 49 is located in another intermediate portion comprising drainage openings 44, wherein the intermediate portions are separated by a divider. Such as in this embodiment, it is preferred that at least one of opening 48 and opening 49 have an elongated shape that is similar to elongated opening 46 and elongated opening 47 to further promote adaptability to different sizes and shapes of windows for drainage. Some other exemplary embodiments may, however, have different shapes of such openings.

In the exemplary embodiment of FIGS. 1-3, the drainage apparatus 10 has a length of about 11 feet and a width of about 3 inches. On the other hand, the drainage apparatus 40 of FIG. 4 also has a length of about 11 feet and a width of about 6.5 inches. Other exemplary embodiments may have a shorter or longer length and width. Also, other exemplary embodiments may have any other dimensions and shapes (e.g., angular, round, curved, etc.) that enable the drainage apparatus to be secured to the face of the intended window for drainage.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the invention. It is the intention, therefore, to limit the invention only as indicated by the scope of the claims.

What is claimed is:

1. A drainage apparatus adapted to extend over a window for drainage, said drainage apparatus comprising:
at least one piece of sheet metal defining:
a) a first end portion adapted to extend over a face of a window for drainage, said first end portion defining at least one elongated opening configured for receiving a fastener adapted to secure said drainage apparatus, respectively, over different sizes of windows for drainage;
b) a second end portion adapted to extend over a face of a window for drainage, said first end portion defining at least one elongated opening configured for receiving a fastener adapted to secure said drainage apparatus, respectively, over different sizes of windows for drainage; and
c) a middle portion between said first end portion and said second end portion, said middle portion defining a plurality of drainage openings that, respectively, have a dimension of at least two inches.

2. The drainage apparatus of claim 1 wherein said drainage apparatus is substantially planar.

3. The drainage apparatus of claim 1 wherein said drainage apparatus is a unit.

4. The drainage apparatus of claim 1 wherein said first end portion is in an opposing position relative to said second end portion.

5. The drainage apparatus of claim 1 wherein said at least one elongated opening of said first end portion or said second end portion is, respectively, a slot.

6. The drainage apparatus of claim 5 wherein:
said at least one elongated opening of said first end portion is a slot; and
said at least one elongated opening of said second end portion is a slot.

7. The drainage apparatus of claim of claim 1 wherein:
said at least one elongated opening of said first end portion or said second end portion is, respectively, at least a pair of said elongated openings.

8. The drainage apparatus of claim 7 wherein:
said at least one elongated opening of said first end portion is at least a pair of said elongated openings; and
said at least one elongated opening of said second end portion is at least a pair of said elongated openings.

9. The drainage apparatus of claim 1 wherein said plurality of drainage openings of said middle portion, respectively, have a rectangular shape.

10. The drainage apparatus of claim 9 wherein said rectangular shape has a length of about 10 inches.

11. The drainage apparatus of claim 1 wherein said plurality of drainage openings of said middle portion, respectively, have a parallelogram shape.

12. The drainage apparatus of claim 11 wherein said parallelogram shape has a length of about 4.75 inches.

13. The drainage apparatus of claim 1 wherein said middle portion further defines at least one opening configured for receiving a fastener adapted to assist with securing said drainage apparatus, respectively, over different sizes of windows for drainage.

14. The drainage apparatus of claim 13 wherein said at least one opening configured for receiving a fastener is an elongated opening.

15. The drainage apparatus of claim 14 wherein said elongated opening configured for receiving a fastener is a slot.

16. The drainage apparatus of claim 1 wherein said at least one piece of sheet metal is at least a first piece of sheet metal that is secured to a second piece of sheet metal.

17. The drainage apparatus of claim 16 wherein said first piece of sheet metal is welded to said second piece of sheet metal.

18. The drainage apparatus of claim 16 wherein:
said first piece of sheet metal defines said first end portion; and
said second piece of sheet metal defines said second end portion;
wherein said first piece of sheet metal is secured to said second piece of sheet metal to form said middle portion.

19. The drainage apparatus of claim 1 wherein said drainage apparatus has a length of about 11 feet.

20. The drainage apparatus of claim 1 wherein:
said at least one elongated opening of said first end portion has a length of about 4 inches; and
said at least one elongated opening of said second end portion has a length of about 4 inches.
